(19) United States
(12) Patent Application Publication
(10) Pub. No.: US 2014/0319797 A1
(43) Pub. Date: Oct. 30, 2014

(54) QUICK-RELEASE BICYCLE CRANK ASSEMBLY

(71) Applicant: Pacific Cycle, LLC, Madison, WI (US)

(72) Inventor: Lee Emmons, Verona, WI (US)

(73) Assignee: PACIFIC CYCLE, LLC, Madison, WI (US)

(21) Appl. No.: 14/145,272

(22) Filed: Dec. 31, 2013

Related U.S. Application Data
(60) Provisional application No. 61/815,626, filed on Apr. 24, 2013.

(51) Int. Cl. B62M 3/00

(52) U.S. Cl. CPC B62M 3/00
USPC 280/259; 74/594.1

(57) ABSTRACT

A quick release bicycle crank assembly for a bicycle allows installation and removal of cranks from a crankset without the use of tools. The quick release mechanism has a coupling and a spindle wherein the coupling includes an outer sleeve that opens and closes the coupling, thereby allowing the spindle to be inserted or removed from the coupling.

### CROSS-REFERENCE TO RELATED APPLICATION

This application is based on and claims priority to U.S. Provisional Patent Application No. 61/815,626 filed on Apr. 24, 2013, which is incorporated herein by reference in its entirety for all purposes.

### FIELD OF THE INVENTION

The present invention relates generally to the field of bicycle cranksets. More particularly, the present invention relates to a bicycle crank that may be quickly removed from a crankset without the use of tools.

### BACKGROUND

Balance bicycles are popular training bicycles that help children learn how to balance and steer a bicycle without pedaling. Conventional balance bicycles do not include pedals, a crankset and chain, or training wheels. Balance bicycle seats are positioned so the rider can easily touch the ground, allowing him or her to walk the bicycle while sitting comfortably on the saddle. At first, the child walks the bicycle by standing over the saddle, then transitions to walking the bicycle while sitting on the saddle, and finally the rider can run and lift his legs to ride the bicycle as it coasts along, balanced on two wheels. Balance bicycles are thought to allow children to learn how to ride a conventional two-wheeled bicycle easier, or at a younger age, than learning by using training wheels.

Some balance bicycles are convertible into pedal bicycles when the child is ready to learn how to pedal, and include a crankset and chain, but have removable cranks. However, attaching or removing typical cranks on convertible balance bicycles can be a difficult, messy, and tedious process requiring the use of tools. As such, there is a need for a convertible balance bicycle that has cranks attached to a crankset by a quick-release mechanism, where the quick-release mechanism allows the attachment or removal of the cranks without the use of tools.

### BRIEF DESCRIPTION OF THE DRAWINGS

FIG. 1A is a perspective view of one embodiment of a balance bicycle having quick release cranks in accordance with the invention;

FIG. 1B is a partial cutaway view of the balance bicycle having quick release cranks of FIG. 1A showing gears and a chain.

FIG. 2 is an exploded perspective view of one embodiment of a bottom bracket having quick release cranks in accordance with the invention;

FIG. 3 is a partial section view of the bottom bracket having quick release cranks of FIG. 2, taken generally along the line 3-3 in FIG. 1;

FIG. 4A is a detail section view of the bottom bracket having quick release cranks of FIG. 2, showing a crank in an attached position;

FIG. 4B is a detail section view of the bottom bracket having quick release cranks of FIG. 2, showing a crank in a detached position;

FIG. 5 is a detail view of the bottom bracket having the right side quick release cranks of FIG. 2 attached to the bottom bracket, in which the crank arm is horizontal and thus only partially visible;

FIG. 6 is a section view of the quick release crank of FIG. 2, taken generally along the line 6-6 in FIG. 4, showing a left-side crank and attachment spline;

FIG. 7 is a section view of the quick release crank of FIG. 2, taken generally along the line 7-7 in FIG. 4, showing a right-side crank and attachment spline; and

FIG. 8 is a schematic view showing an overlay of the the attachment splines of the quick release cranks of FIGS. 6 and 7.

### SUMMARY OF INVENTION

The present invention relates to a quick release crank assembly for a bicycle. The quick release crank assembly includes a bottom bracket for use with a bicycle frame wherein the bottom bracket includes a spindle that rotates within the bottom bracket, the spindle having two ends, each end including a quick release assembly.

The invention further relates to a bicycle having a quick release crank assembly. The bicycle includes a frame, at least two wheels, handlebars, a saddle, and a bottom bracket. A spindle is rotatable within the bottom bracket, and has two ends that include a quick release assembly at each end. Two cranks, each crank having a spline that may be selectively attached to the quick release assembly.

The quick release crank for a bicycle may be used by providing a bicycle having a bottom bracket including a spindle that rotates within the bottom bracket, the spindle having two ends that include a quick release assembly at each end, and attaching or detaching a crank having a spline that engages the quick released assembly.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### DETAILED DESCRIPTION

The quick-release crank assembly described herein allows a user to attach or remove a crank from a bicycle without the use of tools. As shown, the invention is particularly useful for children's balance bicycles that may be converted to a pedal bicycle when a child is ready to use pedals. The quick-release crank assembly may also be used on any bicycle or other pedal driven vehicle without departing from the invention.

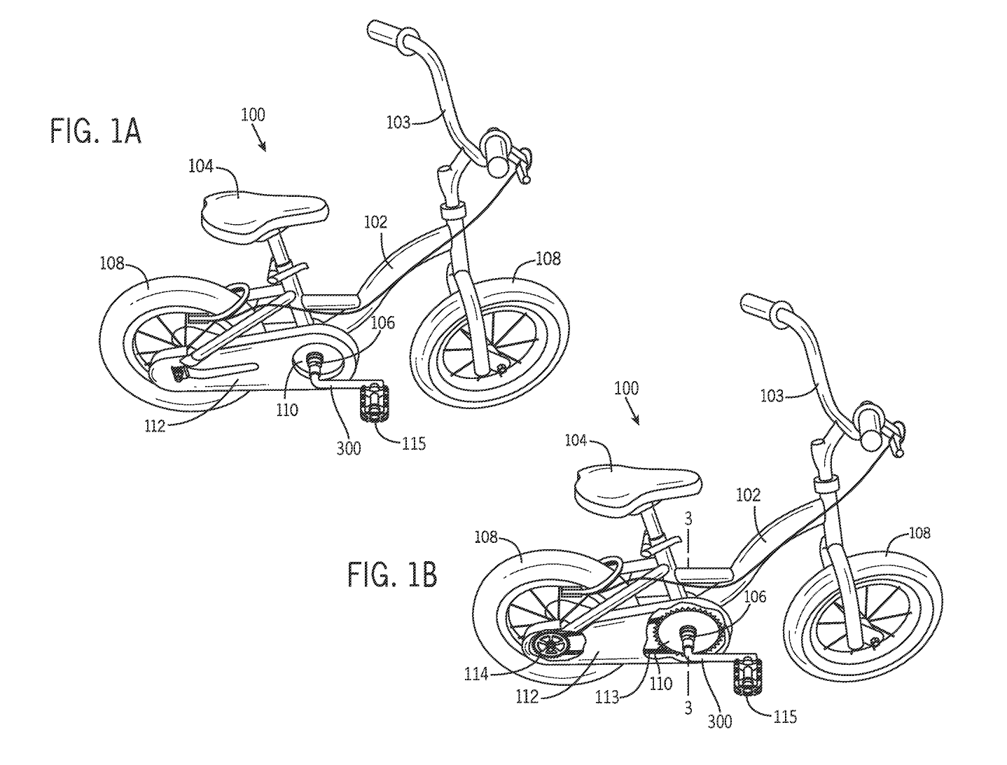

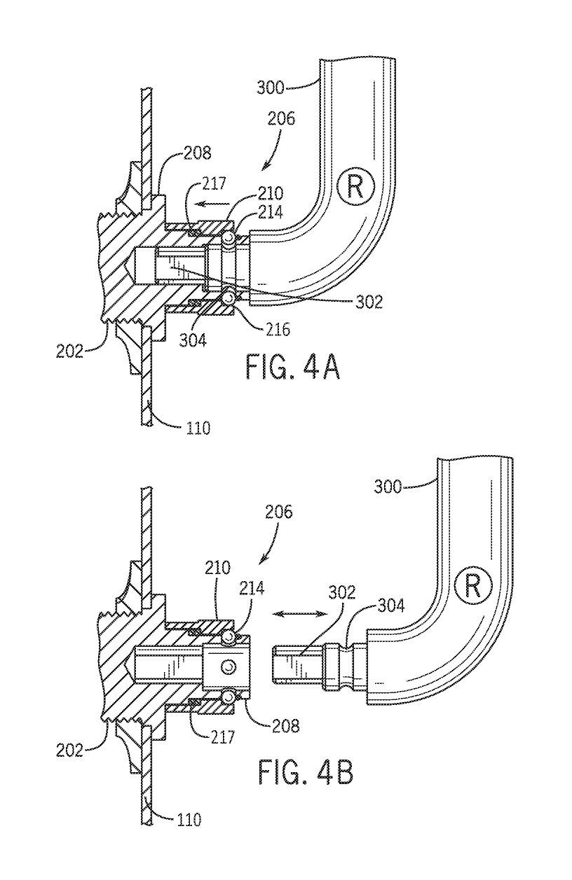

FIGS. 1A and 1B show one embodiment of a convertible balance bicycle 100 having a quick release assembly 200 for attaching or removing cranks 300. The convertible balance bicycle 100 includes a frame 102, handlebars 103, a saddle 104, a crankset 106, and two wheels 108. The crankset 106 includes at least two gears connected by a chain. In the embodiment shown, a first gear 110 is attached to a bottom bracket 120, which is located within a bottom bracket shell 111 (see FIG. 4) at the bottom of the frame 102 generally below the saddle 104. A chain 113 mechanically attaches the first gear 110 to a second gear 114 at the rear of the bicycle that drives one of the wheels 108 when the first gear is turned. The first gear 110 may be turned by a user when cranks 300 are attached to the first gear. One pedal 115 is attached to each crank 300 and allows a user to turn the cranks by pressing on the pedals. A chain guard 112 prevents a rider and/or his clothing from getting caught in the chain. The chain guard 112 is optional, and alternative drivetrain configurations may also be used without departing from the invention. One such alternative drivetrain configuration are belt driven gears.

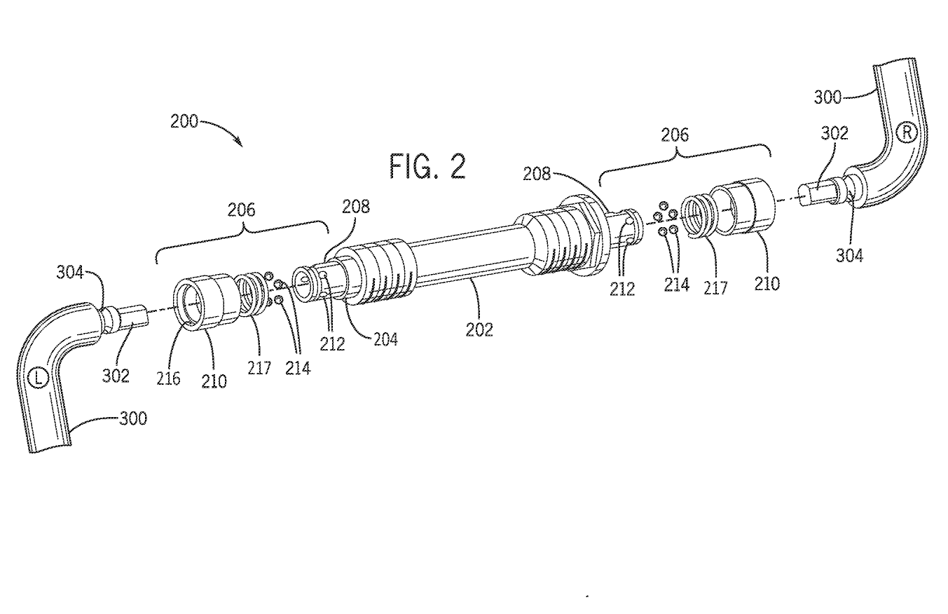

FIG. 2 is an exploded view of one embodiment of a quick release assembly 200 in accordance with the invention. The quick release assembly 200 has a bottom bracket 202, which includes a spindle 204 and bearings that allow the spindle to rotate. At each end of the spindle 204 is a coupling 206 similar to those used in hydraulic and pneumatic systems. The coupling 206 includes an inner sleeve 208 and an outer sleeve 210. The inner sleeve 208 includes a plurality of holes 212 disposed circumferentially around the inner sleeve, each of which captures a ball bearing 214.

Cranks 300 include a spindle 302 that can be inserted into the coupling 206 when it is in the open position. In the embodiment shown, the spindle 302 is shaped such that it provides the proper alignment of the cranks 300. Further, the embodiment shown includes spindles 302 having unique geometries depending on whether the crank 300 is for the left or right side of the balance bicycle 100. As shown in FIGS. 6-8, the left side crank has a spindle profile having a width of dimension “X,” whereas the right side crank has a spindle profile having a width of “X′.” Providing spindles of unique geometry ensures that a user cannot install the cranks 300 incorrectly. A quick release may be any suitable quick release including a mechanism similar to a “quick-connect” hose connector, bayonet mount, threaded connection, or any other suitable mechanism that allows quick, secure connection of parts without the use of tools.

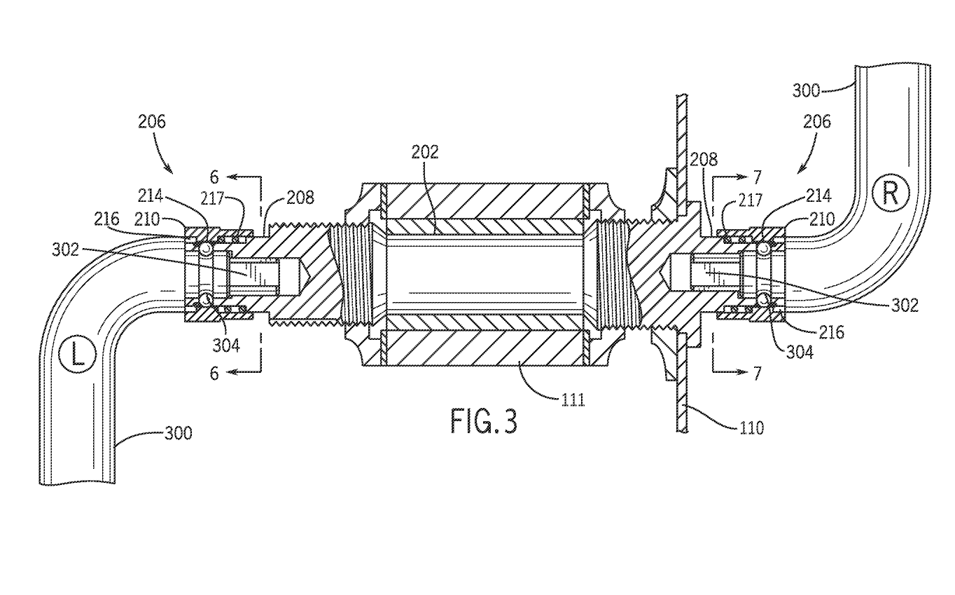

As shown in FIGS. 3, 4A, and 4B, the outer sleeve 210 includes a recess 216 into which the ball bearings 214 travel when a user moves the outer sleeve 210 axially relative to the coupling 206. When the ball bearings 214 are in the recess 216, the coupling 206 is in an “open” position, and a spline 302 may be inserted into the coupling. After spline 302 is inserted, a spring 217 holds the outer sleeve 210 in a “closed” position. Even when the coupling 206 is in an open position, spring 217 biases the outer sleeve toward the closed position. Crank 300 further includes a channel 304 that engages the ball bearings 214 when the spline 302 is inserted into the coupling 206. In an alternative embodiment, the spline 302 may also include a protrusion or similar feature that engages with the notch in the inner sleeve 210 to align the crank 300 to the coupling 206. Like the coupling, the spline 302 may include any suitable alignment means without departing from the invention.

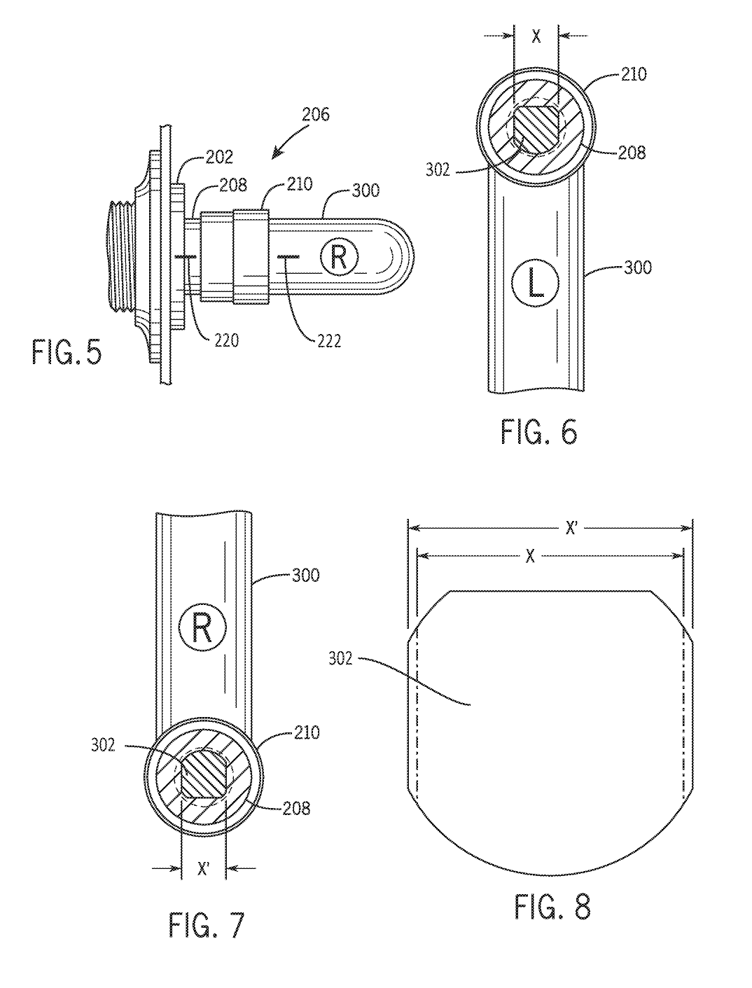

FIG. 5 is a bottom view of one embodiment of a crank 300 and the coupling 206 that has markings 220, 222 on the coupling 206 and the crank to show the correct orientation of the crank to the user. When attaching crank 300 to the coupling 206, the user can thus align marking 220 with marking 222 to ensure proper orientation and fitment of the crank to the crankset 106. The markings 220, 222 shown in FIG. 3 is just one example. Other markings may be used without departing from the invention.

When a child using the convertible balance bicycle 100 is ready to use pedals with the bicycle, an adult may quickly and easily attach cranks 300 to the quick release assembly 200. First, the adult retracts the outer sleeve 210, which allows the ball bearings 214 to travel into recess 216, thereby allowing the spindle 302 to be inserted into the coupling 206. Next, with the outer sleeve retracted 210, the adult inserts the spindle 302 into the coupling 206, taking care to insert the correct crank 300 and to align the markings 220. Finally, when the spline 302 is fully inserted into the coupling 206, the adult simply releases the outer sleeve 210, which causes the spring 217 to move the outer sleeve to the “closed” position, which forces the ball bearings 214 into the channel 304, thereby locking the crank 300 in place. Removing the crank 300 is achieved by retracting the outer sleeve 210 and pulling on the crank 300 to remove it from the coupling 206. In the embodiment shown, the coupling 206 is integral to the spindle 204, but the coupling 206 may alternatively be integral to the crank 300, with the spline 302 integral to the spindle 204.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A crankset for a bicycle comprising:
a bottom bracket for use with a bicycle;
a spindle that is rotatable within the bottom bracket, the spindle having two ends and including a quick release assembly at each end; and
two cranks, each crank having a spline that may be selectively attached to the quick release assembly.

2. The crankset of claim 1, the quick release assembly further comprising a coupling including an inner sleeve and an outer sleeve.

3. The crankset of claim 2, wherein the inner sleeve has a plurality of holes positioned circumferentially around the inner sleeve.

4. The crankset of claim 3, further comprising a plurality of ball bearings disposed in the plurality of holes.

5. The crankset of claim 4, wherein the outer sleeve is slidably attached to the inner sleeve and has a recess into which the ball bearings travel when the outer sleeve is moved to an open position.

6. The crankset of claim 5, wherein the splines have a channel that engages the ball bearings when the outer sleeve is moved to a closed position.

7. The crankset of claim 1, wherein the spline may only be inserted into one of the quick release assemblies and only in a particular orientation.

8. The crankset of claim 1, wherein each coupling and each crank have markings to indicate proper alignment of the crank to the coupling.

9. The crankset of claim 1, wherein the outer sleeve further includes an alignment notch.

10. The crankset of claim 9, wherein the spindle has an alignment protrusion that engages with the alignment notch when the spindle is inserted into the coupling to align the crank with the spindle.

11. The crankset of claim 1, further including a spring between the inner and outer sleeves that that biases the outer sleeve into the closed position.

12. A bicycle having a quick release crank assembly, the bicycle comprising:
a frame;
at least two wheels;
handlebars;
a saddle;
a bottom bracket;
a spindle that is rotatable within the bottom bracket, the spindle having two ends and including a quick release assembly at each end; and
two cranks, each crank having a spline that may be selectively attached to the quick release assembly.

13. A method of using a quick release crank for a bicycle comprising the steps of:
providing a bicycle having a bottom bracket including a spindle that rotates within the bottom bracket, the spindle having two ends and including a quick release assembly at each end;
attaching or detaching a crank having a spline that engages the quick release assembly to the quick release assembly.

14. The method of using a quick release crank of claim 13, wherein each quick release assembly includes an inner sleeve and an outer sleeve, the inner sleeve having a plurality of holes positioned circumferentially around the inner sleeve, a plurality of ball bearings, one ball bearing disposed in each of the holes, the outer sleeve slidably attached to the inner sleeve and having a channel into which the ball bearings travel when the outer sleeve is moved to an open position.

15. The method of using a quick release crank of claim 14, further including the steps of:
retracting the outer sleeve, causing the ball bearings to travel into the channel;
inserting the spindle into the inner sleeve; and
releasing the outer sleeve, causing a spring to move the outer sleeve to the closed position, which forces the ball bearings into the channel.

16. The method of claim 15, further including the steps of:
retracting the outer sleeve;
pulling on the crank to remove the crank from the coupling.
